(19) United States
(12) Patent Application Publication
(10) Pub. No.: US 2008/0190433 A1
(43) Pub. Date: Aug. 14, 2008

(54) Treatment of Spongiform Encephalopathy Using a Hyperbaric Environment

(76) Inventor: Ivan Petyaev, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 11/663,546

(22) PCT Filed: Sep. 23, 2005
(86) PCT No.: PCT/GB05/03694

§ 371 Date: Feb. 14, 2008

(30) Foreign Application Priority Data
Sep. 23, 2004 (GB) 0421243.7

(51) Int. Cl. A61G 10/04

(52) U.S. Cl. 128/205.26

(57) ABSTRACT

The present invention relates to the treatment of spongiform encephalopathy by exposing an individual to a hyperbaric environment having a pressure which is sufficiently increased above atmospheric pressure to dissolve gas in the brain of the individual, thereby reducing the level of gaseous oxygen within the brain of the individual.

This invention relates to the treatment of spongiform encephalopathies.

Spongiform encephalopathies are a class of chronic progressive degenerative conditions affecting the central nervous system which are characterised by spongiform change and extensive PrPc deposition within the brain. There is no treatment, and the conditions are invariably fatal.

Many spongiform encephalopathies have been associated with a transmissible causative agent, which is generally accepted to be a “prion”. The prion agent is an aberrant form of a normal prion protein that causes the normal protein to conform to its aberrant shape, leading to a cascade of abnormal proteins accumulating in brain cells. This accumulation produces holes or cavities within the brain, giving a “sponge-like” appearance.

This spongiform degeneration of the brain is the major distinguishing feature of spongiform encephalopathies. However, the cause of this degeneration and its pathogenesis remain unclear. Experiments in vitro¹, on cell cultures² and on animal models³ show that a pathogenic form of prions alters the activities of antioxidant enzymes. This may stimulate processes of oxidative degradation in the affected human brain. Analysis of cerebrospinal fluid of patients with sporadic and familiar CJD provides indirect indication that processes of lipid peroxidation can be activated in the central nervous system⁴. However, there have been no direct studies of oxidative processes on the brains of patients with CJD.

The present inventors have identified key defects in the oxidative systems in the brains of spongiform encephalopathy sufferers. These defects lead to the production of gaseous oxygen, which builds up in the brains of sufferers and leads to tissue damage, in particular the formation of the cavities within the brain that are characteristic of spongiform encephalopathies.

The present invention, in various aspects, relates to methods and means for treating spongiform encephalopathies by reducing the level of gaseous oxygen within the brain.

One aspect of the invention provides a method of treating a spongiform encephalopathy in an individual comprising or consisting of:
exposing the individual to a hyperbaric environment having a pressure which is sufficiently increased above atmospheric pressure to dissolve gas in the brain of the individual.

The pressure in the environment may then be progressively reduced to atmospheric pressure at a rate sufficient to allow diffusion of the dissolved gas from the brain.

The gas in the brain of spongiform encephalopathy patients is predominantly or exclusively oxygen which is generated by the breakdown of hydrogen peroxide. Three different hydrogen peroxide decomposition reactions may result in the production of molecular oxygen.

Hydrogen peroxide may decompose spontaneously:

2H₂O₂→2H₂O+O₂ [1]

The decomposition process may be catalysed by the presence of metals of transient valence:

2H₂O₂+2Me²⁺→2H₂O+₂Me³⁺+O₂ [2]

Hydrogen peroxide can be reduced by oxidisable compounds which are present in the tissue:

2H₂O₂+2HX→2H₂O+2H⁺+2X+O₂ [3]

Molecular oxygen in the brains of spongiform encephalopathy patients may be produced by any one, two or all three of the above reactions.

Spongiform encephalopathies suitable for treatment in accordance with the present methods include Creutzfeldt-Jakob disease (CJD), Kuru, Gerstmann-Straussler-Scheiker syndrome, scrapies and BSE. CJD may include sporadic, familial, latrogenic and variant CJD.

Treatment of a spongiform encephalopathy in accordance with the present methods may include curing the condition, reducing or ameliorating one or more of symptoms of the disorder, delaying the onset of symptoms, and/or improving the life expectancy/quality of an individual having the condition.

Individuals suitable for treatment by the present methods may include any mammal, in particular domestic or agricultural animals such as sheep and cows. In preferred embodiments, the individual is a human.

A hyperbaric environment suitable for use in the present methods has a pressure which is sufficiently greater than atmospheric pressure to cause gases, such as oxygen, which are generated in the brain tissue to be redissolved. The dissolved gas then diffuses gradually out of the brain.

Pressure may be conveniently measured in atmospheres (atms). One atmosphere equals the pressure of air at sea level (14.7 pounds per square inch (psi)).

Suitable pressures for the dissolving of gases into body tissues may be readily determined by the skilled person.

In some embodiments, the hyperbaric environment may have a pressure of at least 1.1, 1.3, 1.4, 1.5, 1.6, 1.7 or 1.8 atms up to 2, 2.5, 3, 4, 5, 6, 6.8 or 7 atms. Pressures of about 1.4, 1.75 or 2.4 atms may be used in some embodiments.

Exposing the individual to the hyperbaric environment may comprise immersing the entire body of the individual in a gaseous environment which supports the respiration of the individual (e.g. an oxygen-containing gas such as air) but is maintained at an increased or hyperbaric pressure such that gases generated in the brain tissue are redissolved and diffuse out of the brain.

A hyperbaric environment may be provided using a hyperbaric chamber. A hyperbaric chamber is a sealed compartment in which individuals may be placed and then exposed to controlled increases in pressure, for example up to 6.8 atms.

Many different types of hyperbaric chambers exist, ranging from small monoplace (single person) chambers to complex multiple place, multiple lock-out chambers large enough for multiple patients and attendants. Any suitable hyperbaric chamber may be used in accordance with the present methods. A hyperbaric chamber may, for example, be a transportable kevlar chamber (SOS Ltd, London).

The hyperbaric chamber is conveniently at normal atmospheric pressure when the individual enters. The chamber is then sealed and the pressure increased to a level at which gaseous oxygen in the brain of the individual is dissolved. Any suitable rate of pressure increase may be used, but the rate will usually be no more than 1 foot of ascent per second.

The individual may remain in the hyperbaric environment for any period of time which is suitable to facilitate dissolution of gases into body tissues. Suitable lower limits may be at least 30 minutes, 45 minutes or 60 minutes.

Potentially, treatment may last until the clinical effect is achieved. For example, the treatment may last continuously for 60 hours or more. In other embodiments, a single treatment may last up to 2 hours, 3 hours, 4 hours, 5 hours, 6 hours, 7 hours or 8 hours.

Preferably the individual is brought slowly back to surface atmospheric pressure to allow gases to diffuse gradually out of the lungs and body. In other words, the environment may not be decompressed to atmospheric pressure at a rate which does exceeds the ability of the gas saturated tissues to vent the gases by simple diffusion. For example, the pressure in the environment may reduced to atmospheric pressure over at least 5 minutes, at least 10 minutes, at least 15 minutes, at least 20 minutes, at least 25 minutes or at least 30 minutes.

Any suitable rate of decompression may be employed, for example a rate equivalent to up to 25 feet per minute of descent.

Protocols and procedures for recompression therapy for example in the treatment of gas embolism and decompression sickness are well known in the art (Diving Medicine And Recompression Chamber Operations, NAVSEA 0910-LP-708-8000, Washington, D.C., Naval Sea Systems Command, 1999; Bennett P. B., Elliott D. H., The Physiology And Medecine Of Diving. Philadelphia, W B Saunders, 1993).

The hyperbaric environment may comprise an oxygen-containing respiratory gas, such as normal air, to support the respiration of the individual undergoing treatment.

The individual may be treated in accordance with the present methods more than once. For example, the individual may be treated 5 or more, 10 or more, 20 or more, 30 or more, 40 or more or 50 or more times, using methods of the invention.

The individual may be treated in accordance with the present methods periodically, for example daily, weekly, monthly or annually. Periodic treatment as described herein may continue indefinitely.

An individual suitable for treatment in accordance with the present methods may be suffering from a spongiform encephalopathy, may be suspected of suffering from a spongiform encephalopathy, or may be susceptible to spongiform encephalopathy.

Confirmation of a diagnosis of spongiform encephalopathy in an individual generally requires post-mortem analysis of the brain. However, individuals suitable for treatment in accordance with the present methods may be identified using established clinical criteria.

Suitable individuals may, for example, have a progressive neuropsychiatric disorder of a duration greater than 6 months, where routine investigations do not suggest an alternative diagnosis.

In addition an individual may have at least four of the following five symptoms:

(a) early psychiatric symptoms (depression, anxiety, apathy, withdrawal, delusions)
(b) persistent painful sensory symptoms (including both frank pain and/or unpleasant dysaesthesia)
(c) ataxia
(d) myoclonus or chorea or dystonia
(e) dementia

An individual may show a positive tonsil biopsy which is positive for PrP-res.

A method described herein may comprise the step of identifying an individual as having a suspected (i.e. a possible or probable) spongiform encephalopathy. Such an individual is suitable for treatment in accordance with the present methods,

The neurological function of said individual may be assessed before and after treatment as described herein and the effectiveness of the treatment determined. For example, the individual may be assessed for the presence or severity of one or more of; early psychiatric symptoms (e.g. depression, anxiety, apathy, withdrawal, delusions), persistent painful sensory symptoms (e.g. frank pain and/or unpleasant dysaesthesia), ataxia, myoclonus or chorea or dystonia, and dementia. The treatment may be monitored and evaluated by computer tomography, Nuclear magnetic resonance, EEG or other neurological techniques.

In some embodiments, the hyperbaric environment may comprise air with a reduced O₂ content. This may facilitate the diffusion of oxygen from the brain of the individual. Of course, the oxygen content of the environment must be sufficient to support the respiration of the individual during treatment.

Another aspect of the invention provides the use of an air mixture having reduced oxygen content in the manufacture of a medicament for use in the treatment of spongiform encephalopathy. Spongiform encephalopathy may be treated for example using the methods described herein.

Another aspect of the invention provides a hyperbaric chamber adapted for use in a method described herein.

The hyperbaric chamber may be programmed with suitable parameters for the treatment of spongiform encephalopathy.

The hyperbaric chamber may comprise one or more instruments for monitoring neurological function or may be adapted for connection to one or more such instruments. Suitable instruments include computer tomography, nuclear magnetic resonance or EEG apparatus.

In some embodiments, the chamber may comprise one or more detectors for analysis of neurological function in the individual. These detectors may be connected to instruments and apparatus, such as computer tomography, nuclear magnetic resonance or EEG apparatus, located outside the chamber. Instruments and detectors may be connected to data processors, computers and/or image displays.

A chamber may also comprise means to prevent spread of aberrant prions from the patient. For example, the chamber may comprise a disposable lining. The lining may partially or totally line the interior of the chamber and may be arranged such that the individual does not contact the interior of the chamber. After use by the individual, the lining may be disposed of, without the need for further decontamination of the chamber.

The chamber may be decontaminated with radiation and/or chemical sterilising agents after use.

As described above, a low O₂ environment may be advantageous in some embodiments. A chamber may comprise a supply of air with reduced O₂ content, or be adapted for connection to such a source. In other embodiments, the chamber may comprise an O₂ depleter which reduces the O₂ content of the environment.

Another aspect of the invention provides the use of a hyperbaric chamber in the manufacture of a device for use in treating spongiform encephalopathy.

Various further aspects and embodiments of the present invention will be apparent to those skilled in the art in view of the present disclosure. All documents mentioned in this specification are incorporated herein by reference in their entirety.

Certain aspects and embodiments of the invention will now be illustrated by way of example and with reference to the table set out below.

Table 1 shows Superoxide dismutase, peroxidase and catalase activity in the grey matter of the brain of the patient with NvCJD. Enzymatic activities are expressed: for SOD as a reverse level of diformazan staining in riboflavin auto-oxidised system, for peroxidase as a direct level of the density of o-dianisidine oxidised by H₂O₂, for catalase in μM H₂O₂/min/ml.

### EXAMPLES

We tested two major antioxidant enzymes, superoxide dismutase (SOD) and catalase, in the cerebellum and cortex of a patient who had died from new variant Creutzfeld-Jakob disease (NvCJD). An achromatic staining pattern for SOD showed that this activity is present mainly in the grey matter, and in particular in neuron cytoplasm, of both the cerebral and cerebellar cortex. Comparison of these samples with similar ones from the brain of a healthy person, who died in a traffic accident, and a person, who died from complications of motor neuron disease, revealed a significant loss of SOD activity in the brain of the patient with NvCJD. There was a 2-fold reduction in the cerebellar cortex and 6-fold reduction in cerebral cortex (table 1).

Measurement of catalase registered more profound changes. The decrease in activity of the enzyme was 3-fold in cerebellum, but in the cerebral cortex it was reduced to an undetectable level (table 1). The depression of catalase activity leads to an excessive accumulation of hydrogen peroxide, which itself is a powerful oxidant in biological systems. However, it can also be used by SOD as its substrate. As a result of this, one of the main antioxidant enzymes can be converted into its opposite pro-oxidant form, which would be capable of oxidising and damaging biologically important molecules and cellular membranes⁵⁻⁷.

Direct staining for peroxidase activity of SOD shows strong activity in both cerebral and cerebellar cortices taken from the patient with NvCJD, but no activity was detectable in the control (table 1). A specific inhibitor of SOD, diethyldithiocarbamate, completely abolished the peroxidase activity of the enzyme.

In NvCJD loss of antioxidant enzymatic defence and appearance of measurable SOD-peroxidase activity was observed in brain areas that show spongiform degeneration of neurons and accumulation of abnormal prions, namely cerebral and cerebellar cortex⁸.

### REFERENCES

1. Brown, D. R. Biochem. J., 352, 511-518 (2000).
2. Milhavet, O. et al. Proc Natl. Acad. Sci. USA, 97, 13937-13942 (2000).
3. Lee, D. W. et al. Free Radic. Res., 30, 499-507 (1999).
4. Minghetti, L. et al. J. Neuropathol. Exp. Neurol., 59, 866-871 (2000).
5. Hodgson, E. K., and Fridovich, I. Biochemistry, 14, 5294-5299 (1975).
6. Yim, M. B., Chock, P. B., and Stadtman, E. R. J. Biol. Chem., 268, 4099-4105 (1993).
7. Petyaev, I. M. in Superoxide Dismutase: Recent Advances and Clinical Applications (ed. Edeas, M. A.) 40-44 (Mel Paris, Paris-Tokyo, 1999).
8. Dearmond, S. J., and Prusiner S. B. in Greenfield's Neuropathology (eds Graham, D. I., and Lantos P. L.) 235-280 (Arnold, London-Sydney-Auckland, 1997).

TABLE 1

| | Cerebral cortex | | Cerebellum | |
|---|---|---|---|---|
| Activities | Grey matter | White matter | Grey matter | White matter |

Control

| | | | | |
|---|---|---|---|---|
| SOD | 1.2 ± 0.14 | 0.2 ± 0.07 | 0.8 ± 0.09 | 0.2 ± 0.04 |
| peroxidase | 0.4 ± 0.50 | 1.2 ± 0.34 | 0.2 ± 0.21 | 1.2 ± 0.16 |

| | | |
|---|---|---|
| catalase | 33 ± 2.7 | 28 ± 3.1 |

MND

| | | | | |
|---|---|---|---|---|
| SOD | 1.2 ± 0.29 | 1.1 ± 0.27 | 0.4 ± 0.08 | 0.3 ± 0.45 |
| peroxidase | 0.3 ± 0.05 | 2.3 ± 0.21 | 0.8 ± 0.15 | 2.7 ± 0.97 |

| | | |
|---|---|---|
| catalase | 25 ± 3.9 | 22 ± 2.5 |

NvCJD

| | | | | |
|---|---|---|---|---|
| SOD | 0.2 ± 0.06 | 0.1 ± 0.09 | 0.4 ± 0.06 | 0.2 ± 0.03 |
| | p < 0.01 | p > 0.05 | p < 0.05 | p > 0.05 |
| peroxidase | 5.7 ± 0.42 | 3.4 ± 0.45 | 2.4 ± 0.21 | 1.5 ± 0.29 |
| | p < 0.001 | p > 0.05 | p < 0.01 | p > 0.05 |

| | | |
|---|---|---|
| catalase | 0 ± 2.6 | 8.1 ± 1.2 |
| | p < 0.001 | p < 0.01 |

1. A method of treating a spongiform encephalopathy in an individual comprising:
exposing the individual to a hyperbaric environment having a pressure which is sufficient to dissolve gas in the brain of the individual.

2. A method according to claim 1 comprising progressively reducing the pressure in the environment to atmospheric pressure at a rate sufficient to allow diffusion of the dissolved gas from the brain.

3. A method according to claim 1 wherein the gas is oxygen.

4. A method according to claim 1 wherein the individual is human.

5. A method according to claim 4 wherein the spongiform encephalopathy is Creutzfeldt-Jakob disease.

6. A method according to claim 5 wherein the spongiform encephalopathy is variant Creutzfeldt-Jakob disease.

7. A method according to claim 1 wherein the environment has a pressure of 1.1 to 7 times atmospheric pressure.

8. A method according to claim 1 wherein the environment comprises normal air.

9. A method according to claim 1 wherein the environment comprises air with a reduced O₂ content.

10. A method according to claim 1 wherein the individual is placed in a hyperbaric chamber.

11. A method according to claim 1 wherein the individual remains in the hyperbaric environment for at least 0.5 hours.

12. A method according to claim 1 wherein the individual is exposed to the hyperbaric environment more than once.

13. A method according to claim 1 wherein the neurological function of said individual is assessed before and after said treatment.

14. Use of a hyperbaric environment having a pressure which is sufficient to dissolve gas in the brain of an individual in the manufacture of a medicament for use in the treatment of a spongiform encephalopathy.

15. Use according to claim 14 wherein the gas is oxygen.

16. Use according to claim 14 wherein the individual is human.

17. Use according to claim 16 wherein the spongiform encephalopathy is Creutzfeldt-Jakob disease.

18. Use according to claim 17 wherein the spongiform encephalopathy is variant Creutzfeldt-Jakob disease.

19. Use according to claim 14 wherein the hyperbaric environment has a pressure of 1.1 to 7 times atmospheric pressure.

20. Use according to claim 14 wherein the environment comprises normal air.

21. Use according to claim 14 wherein the environment comprises air with a reduced O₂ content.

22. A hyperbaric chamber adapted for use in a method according to claim 1.

23. Use of a hyperbaric chamber in the treatment of spongiform encephalopathy.

24. Use of a hyperbaric chamber in the manufacture of a device for use in the treatment of spongiform encephalopathy

25. Use of an air mixture having reduced oxygen content in the manufacture of a medicament for use in the treatment of spongiform encephalopathy.
